(19) United States
(12) Patent Application Publication
(10) Pub. No.: US 2006/0264122 A1
(43) Pub. Date: Nov. 23, 2006

(54) Connector assembly

(75) Inventors: Kathryn Aman, Shoreview, MN (US); Douglas A. Heitkamp, White Bear Lake, MN (US); Stuart Heitkamp, White Bear Lake, MN (US); Stuart R. Chastain, Shoreview, MN (US); Russell L. Hoeker, Maple Grove, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Cardiac Pacemakers, Inc.

(21) Appl. No.: 11/135,056

(22) Filed: May 23, 2005

(51) Int. Cl. H01R 13/187

(52) U.S. Cl. 439/843

(57) ABSTRACT

A header for an implantable pulse generator includes a header body having a passage and a header contact located within the passage to receive a corresponding contact of a lead. The header contact includes an MP35N alloy material having been heat-treated at about 1950° F. or less for about 5 minutes or less.

### FIELD OF THE INVENTION

This invention relates to the field of implantable devices, and more specifically to a connector assembly for an implantable device.

### BACKGROUND

Leads implanted in or about the heart have been used to reverse certain life threatening arrhythmia, or to stimulate contraction of the heart. Electrical energy is applied to the heart via electrodes on the leads to return the heart to normal rhythm.

A header on an implantable device is used to couple a conductor of a lead with the implantable device. For instance, a connector assembly in the header is used to couple a cardiac stimulator system such as a pacemaker, an anti-tachycardia device, a cardiac heart failure device, a cardioverter or a defibrillator with a lead having an electrode for making contact with a portion of the heart.

It is desirable that the connection between the lead and the header is mechanically and electrically reliable.

### SUMMARY

A header for an implantable pulse generator includes a header body having a passage and a contact located within the passage to receive a corresponding contact of a lead. The header contact includes an MP35N alloy material having been heat-treated at about 1950° F. or less for about 5 minutes or less.

### BRIEF DESCRIPTION OF THE DRAWINGS

FIG. 1 shows a view of an implantable system according to at least one embodiment.

FIG. 2 shows a cross-section side view of a header of the implantable device of FIG. 1.

FIG. 3 shows a side view of an electrical connector of the header of FIG. 2.

FIG. 4 shows a front view of the electrical connector of FIG. 3.

FIG. 5 shows a method of forming an electrical connector, according to at least one embodiment.

FIG. 6 shows a view of a surface of a non-treated electrical connector.

FIG. 7 shows a view of a surface of a treated electrical connector, according to at least one embodiment.

FIG. 8 shows an end view a header contact according to at least one embodiment.

FIG. 9 shows a side view of a header, according to at least one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

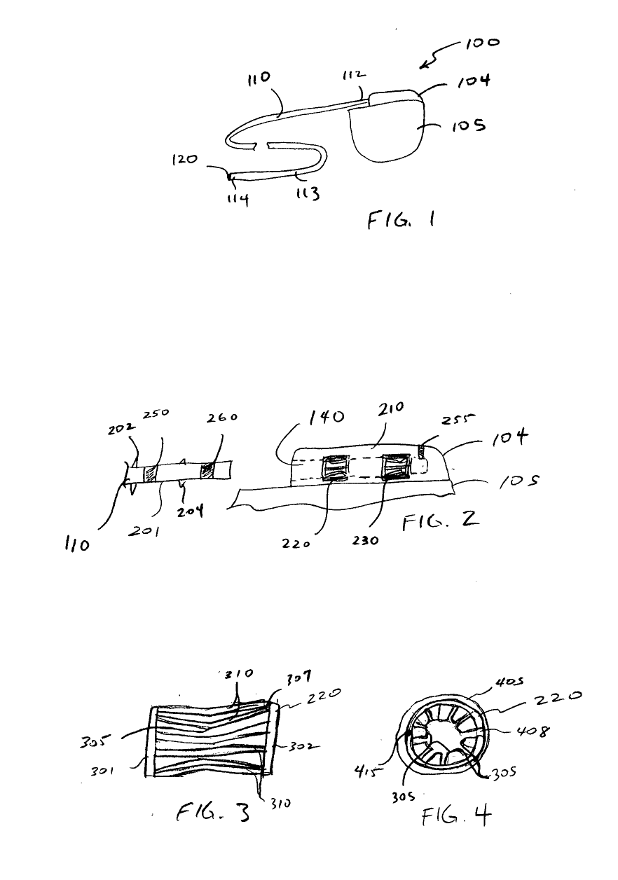

FIG. 1 shows an implantable system 100, in accordance with one embodiment. System 100 includes a pulse generator 105 and at least one lead 110. The pulse generator 105 includes a source of power as well as an electronic circuitry portion, and has a header 104. The pulse generator 105 includes a battery-powered device which generates a series of timed electrical discharges or pulses. The pulse generator 105 is generally implanted into a subcutaneous pocket made in the wall of the chest. Alternatively, the pulse generator 105 is placed in a subcutaneous pocket made in the abdomen, or in other locations. Pulse generator 105 can include a power supply such as a battery, a capacitor, and other components housed in a case. The device can include microprocessors to provide processing, evaluation, and to determine and deliver electrical shocks and pulses of different energy levels and timing for defibrillation, cardioversion, and pacing to a heart in response to cardiac arrhythmia including fibrillation, tachycardia, heart failure, and bradycardia.

Lead 110 includes a lead body 113 having a proximal end 112, where the lead is coupled at the header 104 of pulse generator 105, as further discussed below. The lead 110 extends to a distal end 114, which is coupled with a portion of a heart, when implanted. The distal end 114 of the lead 110 includes at least one electrode 120 which electrically couples the lead 110 with a heart. At least one electrical conductor is disposed within the lead 110 and extends from the proximal end 112 to the electrode 120. The electrical conductors carry electrical current and pulses between the pulse generator 105 and the electrode 120.

In other embodiments, system 100 is suitable for use with implantable electrical stimulators, such as, but not limited to, pulse generators, neuro-stimulators, skeletal stimulators, central nervous system stimulators, or stimulators for the treatment of pain.

FIG. 2 schematically illustrates a side section view of header 104, in accordance with one embodiment. The header 104 includes one or more passages 140 that are configured to receive a lead terminal 201 of lead 110. In this example, lead terminal 201 is an IS-1 standard connector. Lead terminal 201 includes terminal ring contacts 250, 260 and sealing rings 202, 204, which help seal the passage against body fluids. Terminal ring contacts 250, 260 can include standard IS-1 type terminal rings or other terminal contact designs. Terminal ring contacts 250, 260 are typically made of stainless steel. Each terminal ring 250, 260 is coupled via a conductor to at least one electrode disposed on lead 11.

Header 104 generally includes a header body 210 having the passage 140 formed therein and one or more electrical contacts 220, 230 located within the passage 140 to contact corresponding contacts 250, 260, respectively, of lead 110. Contacts 220, 230 are electrically connected to the electronics in pulse generator 105. Passage 140 can be molded within body 210 and sized to receive terminal 201. In some examples, the passage can include a series of decreasing diameter sections defining a series of steps, with one or more contact 220, 230 located within each step. Likewise, the terminal 201 can include a stepped design with a series of decreasing diameter portions with one or more contacts 250, 260 on each section. Furthermore, in some embodiments, the device can include an optional set-screw 255 to help hold the lead terminal in place within the header 104. Other embodiments omit the set-screw.

In one embodiment, contacts 220, 230 are formed so as to provide optimal electrical and mechanical properties. For example, the electrical contacts 220, 230 can be formed of an MP35N metal alloy material that is heat-treated prior to forming the contact. MP35N alloy is a nickel-cobalt-chromium-molybdenum metal alloy. In this example, contacts 220, 230 are leaf spring contacts. The heat-treating of the MP35N alloy material helps provide a smoother surface on the leaf springs which mitigates corrosion during use. In other embodiments, the improved material can be utilized in a wide variety of contacts, such as leaf spring contacts and curled spring contacts. The present header contacts 220, 230 provide improved smoothness which leads to less corrosion by removing a major cause of such corrosion, the scratching or grooving of the terminal rings 250, 260 of lead terminal 201 as it is inserted through the contacts.

In the past, the stamping of the header contact from the base material resulted in cracks on the surface of the contact. As a terminal is then inserted through the contact, the cracks can gouge and scar the terminal ring contacts and thereby encourage corrosion. The relatively smooth surface of the present header contacts 220, 230 minimizes such gouging.

In some embodiments, two or more contacts 220, 230 are located within the passage 140. As will be discussed below, other embodiments can include less or more contacts.

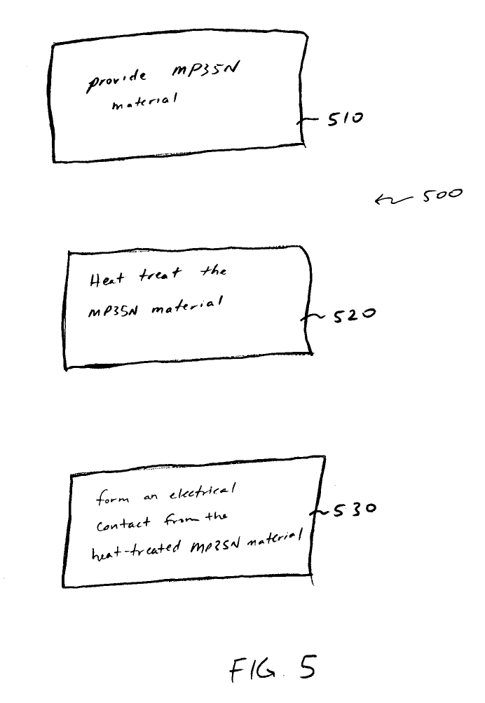

FIGS. 3 and 4 show further details of leaf spring electrical contact 220, in accordance with one embodiment. Contact 230 includes similar features. Referring to FIG. 3, contact 220 includes a main body 307 with ten leaves 310. Other embodiments can utilize more or fewer leaves as desired. The contact includes a first end portion 301 and a second end portion 302 with the leaves extending from one end portion to the other. The contact 220 can include a cylindrical body 307 including a plurality of leaf spring members 310 extending longitudinally along the cylindrical body. The leaves 310 have strength to provide sufficient force against lead terminal ring contact 250 (FIG. 2) to provide sufficient electrical and mechanical contact between the lead and the header. The ten leaves 310 are vertically sloped with a crease in the middle thereby forming a peak or projection 305. These projections 305 are radially deflected when a lead is inserted through the contact.

Referring to FIG. 4, in one embodiment the contact 220 is curled into a cylindrical housing 405 made of 316L stainless steel. In one example, the spring contact 220 is curled in such a way that it does not quite form a complete enclosure inside the housing 405, thus leaving a small gap 408, in one example. The spring contact 220 is spot welded 415 to the housing on one end of the contact, opposite the gap. When the contact is rolled into the housing, the projections 305 define a circle, with the inner diameter of the circle smaller than the outer diameter of the lead terminal ring contact 250 (FIG. 2). This causes each leaf 310 to deflect upon insertion of the lead and thereby exert a radial force on the lead ring contact 250 (FIG. 2) to maintain electrical contact. Because the weld 415 only constrains the spring axially in one spot, the spring expands its axial length inside the housing as it deflects upon lead insertion. The spring also expands into gap 408. In one embodiment, the contact 220 within housing 405 can be press-fit into the header 104 (FIG. 2) with either end facing the bore header. In other embodiments, more than one weld can be used to secure the spring contact in the housing 405. In one embodiment, no welds are used and the spring contact is merely positioned within the housing.

In one example, the spring contact 220 includes an inner diameter of about 0.0988 inches to about 0.1014 inches. This is the size for a 0.106 lead pin, such as for an IS-1 lead terminal diameter. Other embodiments utilize almost any diameter, according to lead terminal size.

FIG. 5 shows a method 500 according to one embodiment. Method 500 describes an example of forming a header contact as discussed herein. Method 500 includes providing a sheet of MP35N alloy material (510), heat treating the MP35N alloy material at between about 1650° F. to about 1950° F. for between about 30 seconds to about 5 minutes (520), and forming the heat-treated MP35N alloy material into a contact (530).

In one example, providing MP35N alloy material includes providing a 0.0025 inch thick cold-worked MP35N alloy.

Heat treating of the MP35N alloy material is done to initiate stress relief (which happens at about 1650° F.) without causing a recrystallization of the material (which happens at about 1950° F.). In other words, one goal is to provide stress relief to the material without causing a phase change. In one or more embodiments, heat treating of the MP35N alloy is done in a non-oxidizing atmosphere. For example, the heat treating can be done in an inert gas atmosphere or in a vacuum.

In some embodiments, heat treating the MP35N alloy material can include heat-treating at between about 1950° F. or less. In some embodiments heat treating the MP35N alloy material includes heat-treating at between about 1675° F. to about 1900° F. Some embodiments heat-treat at between about 16750° F. to about 1800° F. One embodiment heat-treats the material at about 1700° F. In further examples, the material can be heat treated for between about 1 minute to about 5 minutes. In some examples, the heat-treating is done for between about 1 minute to about 2 minutes. In one embodiment, the heat-treating is done for about 2 minutes. In one embodiment, heat heat-treating is done for about 5 minutes or less.

In one option, after being heat-treated, the material is cooled in a non-oxidization atmosphere, for example in an inert gas atmosphere or a vacuum. For example, the material can be allowed to cool at room temperature in a non-oxidizing atmosphere.

After the material is heat-treated it is formed into a contact. For example, the desired shape can be stamped from the heat-treated MP35N alloy material. As discussed above, and below, the MP35N alloy material can be used for a variety of applications including an electrical contact for a header for an IS-1 standard type lead connector, a header for an IS-4 standard type lead connector, and a header for a LV-1 standard type lead connector. The material can be formed into a leaf spring contact, a curled spring contact, or other type of contact.

Heating at between 1650° F. and 1900° F. for relatively short times relieves residual stress and achieves a limited recovery of ductility without decreasing strength to the fully annealed level. The benefit is a reduced potential for the MP35N alloy material to form stress cracks and fissures along grain boundaries during stamping and forming operations. Accordingly, a much smoother surface is developed and the smooth spring contact allows the connection system to have an improved corrosion resistance because of its smoothness and absence of cracks.

The heat-treating described above results in a spring contact that retains its spring characteristics such that the mechanical properties of the spring contact are not substantially changed. In other words, the yield point of the spring contact does not change too much, while the smoothness of the surface of the contact is greatly improved.

As discussed, preventing of formation of the cracks and fissures during the stamping operation reduces the potential for particles from a terminal lead ring of the mating lead to become lodged or trapped in the cracks of the spring at the electrical interface site, which can enable a corrosion mechanism. Another potential benefit results from a lower insertion force required for the introduction of the lead terminal through the ring contact in the header.

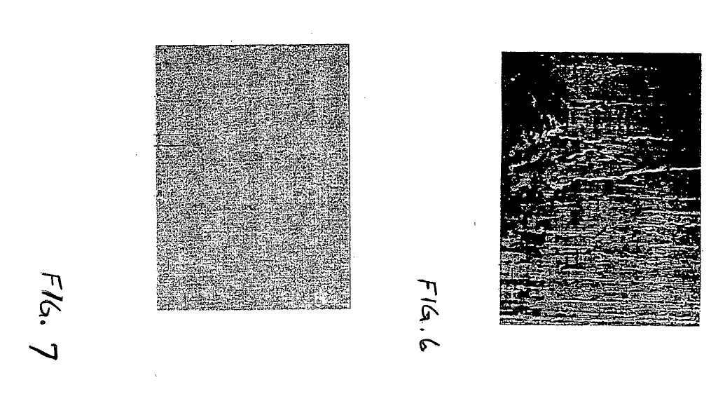

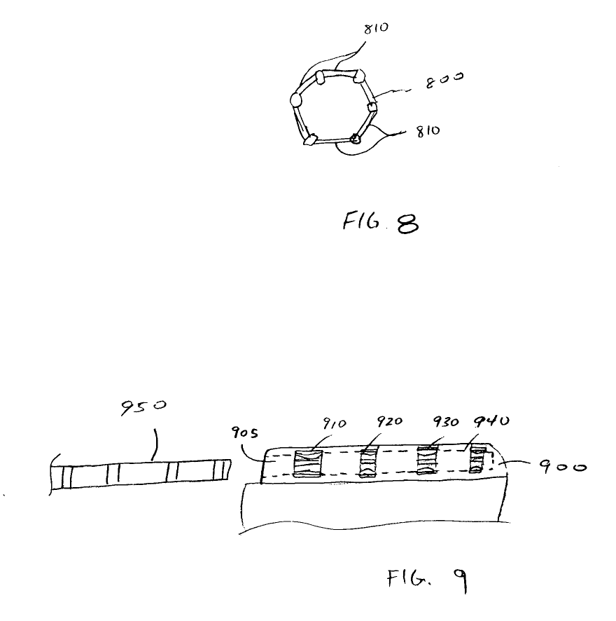

FIGS. 6 and 7 show non-heat-treated and heat-treated contacts, respectively. As can be seen, the heat-treated material of FIG. 7 has far fewer cracks than the material of FIG. 6. This results in a smoother surface. Accordingly, when a lead is inserted into the header the lead does not catch on the cracks which can scratch the contacts and cause corrosion. In contrast, the present contacts of FIG. 7 provide a smooth surface with relatively little gouging of the lead.

In one embodiment, a header contact as discussed herein can be formed as a curled spring. FIG. 8 shows an end view of a curled spring contact 800. In one embodiment, curled spring contact 800 includes a six leaf design with leaves 810. Spring contact 800 can be assembled in a cylindrical housing, such as housing 405 discussed above, and mounted within a header.

FIG. 9 shows a header 900 according to one embodiment. In one embodiment, header 900 can include at least four contacts 910-940 located within a passage 905 and spaced to contact an IS-4 type lead contact 950. An IS-4 type lead includes four ring electrodes on the proximal connecting pin. In one embodiment, contacts 910-940 can include curled spring contacts such as contact 800 (FIG. 8).

The improved smoothness of the spring contacts discussed herein allows for lead terminals having a wider range of terminal ring contact materials. The heat treating reduces residual stress which leads to fewer cracks when the part is stamped. This in turn reduces metallic particle build-up at the contact site to help reduce pitting corrosion in implant conditions (including electrical current.) Accordingly, the spring contacts are more tolerant of variations in material properties of the mating lead terminal ring contact, and the heat-treated MP35N alloy material thus provides an improvement in electromechanical performance for the spring contact it is used in. Moreover, the smoothness of the contact surface also leads to less gouging and damage of the seals of the lead terminal connector. Gouging of the seals can also lead to problems with resistance and can possibly allow fluids in the header.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A header for an implantable pulse generator, the header comprising:
a header body having a passage formed therein; and
a header contact located within the passage to contact a corresponding contact of a lead inserted in the passage;
wherein the header contact includes an MP35N alloy material having been heat-treated at between about 1650° F. to about 1950° F. for between about 30 seconds to about 5 minutes.

2. The header of claim 1, wherein the header contact includes a cylindrical body including a plurality of leaf spring members extending longitudinally along the cylindrical body.

3. The header of claim 1, wherein the header contact includes a curled spring.

4. The header of claim 1, further comprising two or more header contacts located within the passage.

5. The header of claim 1, wherein the header contact includes an MP35N alloy material having been heat-treated at between about 1675° F. to about 1900° F.

6. The header of claim 1, wherein the header contact includes an MP35N alloy material having been heat-treated at between about 1675° F. to about 1800° F.

7. The header of claim 1, wherein the header contact includes an MP35N alloy material having been heat-treated for between about 1 minute to about 5 minutes.

8. The header of claim 1, wherein the header contact includes an MP35N alloy material having been heat-treated for between about 1 minute to about 2 minutes.

9. A header contact comprising:
a contact body including a plurality of spring members, the contact body including an MP35N alloy material having been heat-treated at about 1950° F. or less for about 5 minutes or less.

10. The header contact of claim 9, wherein the header contact includes an MP35N alloy material having been heat-treated at between about 1675° F. to about 1900° F.

11. The header of claim 9, wherein the header contact includes an MP35N alloy material having been heat-treated at between about 1675° F. to about 1800° F.

12. A header contact comprising:
a contact body including a plurality of contact members, the contact body including an MP35N alloy material having been heat-treated at between about 1650° F. to about 1950° F. for between about 30 seconds to about 5 minutes.

13. The header contact of claim 12, wherein the contact includes an MP35N alloy material having been heat-treated at between about 1675° F. to about 1900° F.

14. The header contact of claim 12, wherein the contact includes an MP35N alloy material having been heat-treated at between about 1675° F. to about 1800° F.

15. The header contact of claim 12, wherein the contact includes an MP35N alloy material having been heat-treated at about 1700° F.

16. The header contact of claim 12, wherein the contact includes an MP35N alloy material having been heat-treated for between about 1 minute to about 5 minutes.

17. The header contact of claim 12, wherein the contact includes an MP35N alloy material having been heat-treated for between about 1 minute to about 2 minutes.

18. The header contact of claim 12, wherein the contact includes an MP35N alloy material having been heat-treated for about 2 minutes.

19. A method comprising:
heating an MP35N alloy material at between about 1650° F. to about 1950° F. for between about 30 seconds to about 5 minutes; and
forming the MP35N alloy material into a header contact for an implantable device.

20. The method of claim 19, wherein heating the MP35N alloy material includes heating the material at between about 1675° F. to about 1900° F.

21. The method of claim 19, wherein heating the MP35N alloy material includes heating the material at between about 1675° F. to about 1800° F.

22. The method of claim 19, wherein heating the MP35N alloy material includes heating the material at about 1700° F.

23. The method of claim 19, wherein heating the MP35N alloy material includes heating the material for between about 1 minute to about 5 minutes.

24. The method of claim 19, wherein heating the MP35N alloy material includes heating the material for between about 1 minute to about 2 minutes.

25. The method of claim 19, wherein heating the MP35N alloy material includes heating the material for about 2 minutes.

26. The method of claim 19, including cooling the MP35N alloy material in a non-oxidizing atmosphere after heating the MP35N alloy material.

27. The method of claim 19, wherein forming the MP35N alloy material into a header contact includes stamping a spring contact from the MP35N alloy material.
